(19) United States
(12) Patent Application Publication
(10) Pub. No.: US 2014/0072089 A1
(43) Pub. Date: Mar. 13, 2014

(54) METHOD AND SYSTEM FOR AN ALTERNATIVE BWR CONTAINMENT HEAT REMOVAL SYSTEM

(71) Applicants: Robert J. GINSBERG, Wilmington, NC (US); John R. BASS, Wilmington, NC (US); Robert A. AYER, Wilmington, NC (US); Richard M. ROGERS, Wilmington, NC (US)

(72) Inventors: Robert J. GINSBERG, Wilmington, NC (US); John R. BASS, Wilmington, NC (US); Robert A. AYER, Wilmington, NC (US); Richard M. ROGERS, Wilmington, NC (US)

(73) Assignee: GE-HITACHI NUCLEAR ENERGY AMERICAS LLC, Wilmington, NC (US)

(21) Appl. No.: 13/611,384

(22) Filed: Sep. 12, 2012

(51) Int. Cl. G21C 15/00

(52) U.S. Cl. 376/298

(57) ABSTRACT

A method and apparatus for an alternative cooling system used to cool the suppression pool of a Boiling Water Reactor (BWR) nuclear reactor. The cooling system includes a cooling coil in an isolation condenser located at an elevation that is above the suppression pool. The isolation condenser is connected to the suppression pool via inlet and outlet pipes. The system may provide a natural convection flow of fluids between the suppression pool and the cooling coils to passively cool fluid from the suppression pool without requiring external electrical power.

### BACKGROUND OF THE INVENTION

1. Field of the Invention

Example embodiments relate generally to nuclear reactors, and more particularly to a method and system for an alternative boiling water nuclear reactor (BWR) containment heat removal. The cooling system may be used to passively cool the suppression pool via natural convection circulation. The system may be particularly beneficial in the event a plant emergency that causes plant electrical power to be disrupted, or normal cooling of the suppression pool to otherwise become impaired. The cooling system may also be used by the suppression pool to supplement the conventional residual heat removal system.

2. Related Art

FIG. 1 is a cut-away view of a conventional boiling water nuclear reactor (BWR) reactor building 5. The suppression pool 2 may be a torus shaped pool that is part of the reactor building primary containment (although it should be understood that example embodiments may be applied to other suppression pool configurations used in other BWR reactors with different configurations than the one shown in FIG. 1). Specifically, the suppression pool 2 may be an extension of the steel primary containment vessel 3, which is located within the shell 4 of the reactor building 5. The suppression pool 2 may be positioned below the reactor 1 and spent fuel pool 10, and is used to limit containment pressure increases during certain accidents. In particular, the suppression pool 2 may be used to cool and condense steam released during plant accidents. For instance, many plant safety/relief valves are designed to discharge steam into the suppression pool 2, to condense the steam and mitigate undesired pressure increases. Conventionally, a BWR suppression pool 2 is approximately 140 feet in total diameter (i.e., plot plan diameter), with a 30 foot diameter torus shaped shell. During normal operation, the suppression pool 2 usually has suppression pool water in the pool at a depth of about 15 feet (with approximately 1,000,000 gallons of suppression pool water in the suppression pool 2, during normal operation).

The pool 2 is conventionally cleaned and cooled by the residual heat removal (RHR) system of the BWR plant. During normal (non-accident) plant conditions, the RHR system can remove water from the suppression pool 2 (using conventional RHR pumps) and send the water through a demineralizer (not shown) to remove impurities and some radioactive isotopes that may be contained in the water. During a plant accident, the RHR system is also designed to remove some of the suppression pool water from the suppression pool 2 and send the water to a heat exchanger (within the RHR system) for cooling.

During a serious plant accident, normal plant electrical power may be disrupted. In particular, the plant may be without normal electrical power to run the conventional RHR system and pumps. If electrical power is disrupted for a lengthy period of time, water in the suppression pool may eventually boil and impair the ability of the suppression pool to condense plant steam and reduce containment pressure.

In a plant emergency, use of the RHR system may cause highly radioactive water (above acceptable design limits) to be transferred between the suppression pool and RHR systems (located outside of primary containment). The transfer of the highly radioactive water between the suppression pool and RHR system may, in and of itself, cause a potential escalation in leakage of harmful radioactive isotopes that may escape the suppression pool. Additionally, radiation dosage rates in areas of the RHR system could be excessively high during an accident, making it difficult for plant personnel to access and control the system.

### SUMMARY OF INVENTION

Example embodiments provide a method and/or system for an alternative Boiling Water Reactor (BWR) nuclear reactor containment heat removal. The cooling system may include cooling coils in an isolation condenser that may be located at an elevation above the suppression pool. Inlet and outlet pipes may be used connect the suppression pool and isolation condenser to establish a natural convection flow to passively cool suppression pool water.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a cut-away view of a conventional boiling water nuclear reactor (BWR) reactor building;

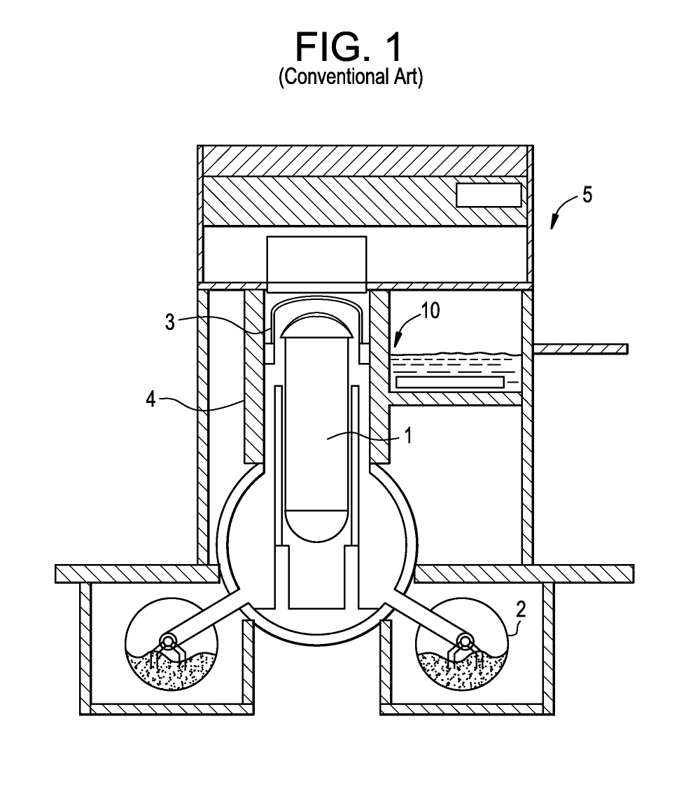

FIG. 2 is a cut-away of a boiling water nuclear reactor (BWR) reactor building, in accordance with an example embodiments;

FIG. 3 is a diagram of an alternative BWR containment heat removal system, in accordance with an example embodiment; and

FIG. 4 is a flowchart of a method of using an alternative BWR containment heat removal system, in accordance with an example embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

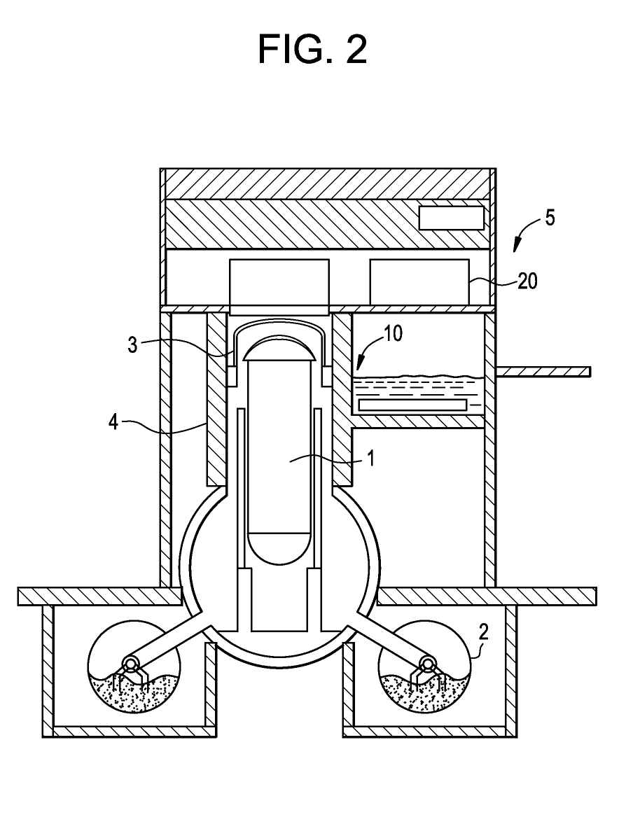

FIG. 2 is a cut-away of a boiling water nuclear reactor (BWR) reactor building, in accordance with an example embodiment. Specifically, an isolation condenser 20 may be included in a position in the reactor building 5 that is located above an elevation of the suppression pool 2.

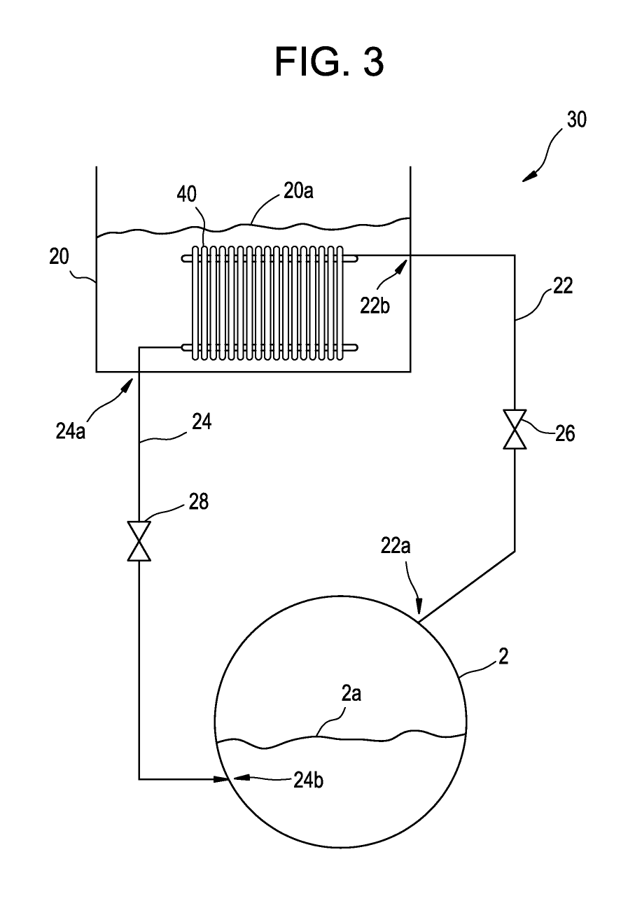

FIG. 3 is a diagram of an alternative BWR containment heat removal (ABCHR) system 30, in accordance with an example embodiment. The system may include an isolation condenser 20 (filled with cool water) located at an elevation that is above the suppression pool 2 (see FIG. 2). The isolation condenser 20 is located above the suppression pool 2 in order to ensure that a natural convection circulation of fluid may be established between the isolation condenser 20 and the suppression pool 2. Cooling coils 40 may be located in the isolation condenser 20. The cooling coil 40 may be a radiator-type cooling coil. Alternatively, the cooling coil 40 may include branched piping, or another configuration that increases the surface area between the coil 40 and the water in the isolation condenser 20.

The cooling coils 40 may be connected to the suppression pool 2 via outlet and inlet pipes 22/24. The outlet pipe 22 may include a manually operated outlet isolation valve 26 that opens and closes the outlet 22 between the isolation condenser 20 and the suppression pool 2. The inlet pipe 24 may also include a manually operated inlet isolation valve 28 that opens and closes the inlet 24 between the isolation condenser 20 and the suppression pool 2. The inlet/outlet isolation valves 26/28 may be manually operated to ensure that external power need not be required to operate the ABCHR system 30.

An outlet pipe discharge point 22a (at the suppression pool 2) of the outlet 22 may be positioned at a location that is at or near a top elevation of the suppression pool 2. Preferably, the outlet discharge point 22a may be located above the normal water level 2a of the suppression pool 2. This ensures that only hot steam and/or water exits the suppression pool 2 via a natural convection flow to be condensed by the cooling coils 40. Likewise, an outlet pipe entry point 22b of the outlet 22 may be located at or near a top elevation of the isolation condenser 20. The outlet 22 may also be connected at or near a top elevation of the cooling coils 40. This ensures that the hot steam/water entering coils 40 may be condensed and drain (via gravity) out of the coils 40 and back into the suppression pool 2. By locating the outlet pipe entry point 22b near a top elevation of the isolation condenser 20, the outlet pipe 22 will also not heat water near a bottom floor of the isolation condenser 20 (to ensure that the inlet pipe 24 near the inlet discharge point 24a is not inadvertently heated.

The inlet pipe discharge point 24a (at the isolation condenser 20) of the inlet 24 may be positioned at a location that is at or near a bottom elevation of the isolation condenser 20. This ensures that only cooler water exits coils 40 and drains back into the suppression pool 2. An inlet pipe entry point 24b of the inlet 24 may be located at or near a bottom elevation of the suppression pool 2 (preferably, below the normal water level 2a of the suppression pool 2), to ensure that the cool water entering entry point 24b is separated from the hot steam/water near top elevations of the suppression pool 2.

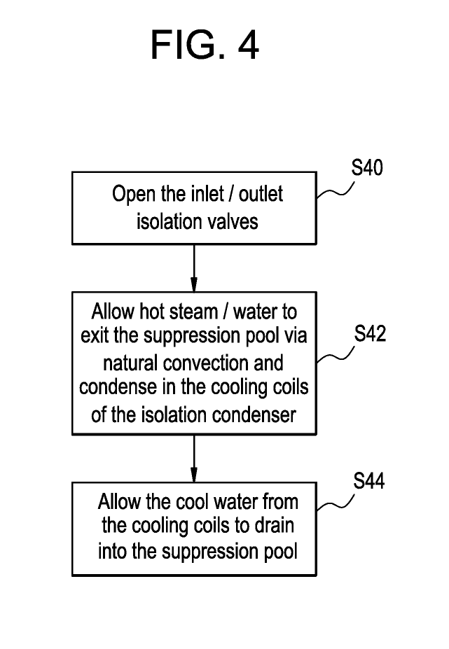

FIG. 4 is a flowchart of a method of using an ABCHR system 30, in accordance with an example embodiment. Step S40 may include opening the outlet and inlet isolation valves 22/24 (FIG. 3) of the system 30 to establish a natural convection flow of fluid between the suppression pool 2 and the cooling coils 40 of the isolation condenser 20. Specifically, step S42 may include allowing hot steam/water to exit the suppression pool 2, via natural convection force, and discharge into the cooling coils 40 to condense and cool the fluid. Step S344 may include allowing the condensed and cooled fluid to drain, via gravity, from the coils 40 of the isolation condenser 20 back into the suppression pool 2. By performing this method, a passive means of cooling the fluid of the suppression pool 2 may be established without the need for an external power source.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A system, comprising:
a suppression pool;
an isolation condenser located at an elevation above the suppression pool, the isolation condenser containing cool water;
a cooling coil located in the isolation condenser; and
an outlet pipe and an inlet pipe connecting the suppression pool to the cooling coil,
wherein the system operates without the need for any external power source.

2. The system of claim 1, wherein,
the outlet pipe is connected to the suppression pool near a top elevation of the suppression pool,
the inlet pipe is connected to the suppression pool near a bottom elevation of the suppression pool.

3. The system of claim 1, further comprising:
an outlet isolation valve in the outlet pipe; and
an inlet isolation valve in the inlet pipe.

4. The system of claim 3, wherein the outlet and inlet isolation valves are manually operated valves.

5. The system of claim 1, wherein,
the outlet pipe is connected to the cooling coil near a top elevation of the cooling coil;
the inlet pipe is connected to the cooling coil near a bottom elevation of the cooling coil.

6. The system of claim 1, wherein,
the cooling coil is a radiator-type cooling coil,
the cooling coil is fully submerged under a normal liquid level of the isolation condenser.

7. A method of making a system, comprising:
positioning an isolation condenser at an elevation above a suppression pool, the isolation condenser containing cool water;
placing a cooling coil in the isolation condenser; and
connecting the suppression pool and the cooling coil via an inlet pipe and an outlet pipe,
wherein the system is operated without the need for an external power source.

8. The method of claim 7, wherein,
the connecting of the suppression pool and the cooling coil includes connecting the outlet pipe to the suppression pool near a top elevation of the suppression pool,
the connecting of the suppression pool and the cooling coil includes connecting the inlet pipe to the suppression pool near a bottom elevation of the suppression pool.

9. The method of claim 7, further comprising:
placing an outlet isolation valve in the outlet pipe; and
placing an inlet isolation valve in the inlet pipe.

10. The method of claim 9, wherein the outlet and inlet isolation valves are manually operated valves.

11. The method of claim 7, wherein,
the connecting of the suppression pool and the cooling coils includes connecting the outlet pipe to the cooling coil near a top elevation of the cooling coil,
the connecting of the suppression pool and the cooling coil includes connecting the inlet pipe to the cooling coil near a bottom elevation of the cooling coil.

12. The method of claim 7, wherein,
the placing of the cooling coil in the isolation condenser including fully submerging the cooling coil below a normal liquid level of the isolation condenser,
the cooling coil being a radiator-type cooling coil.

13. The method of using the system of claim 3, comprising:
opening the inlet and outlet isolation valves to establish a natural convection force between the suppression pool and the cooling coil;
allowing hot fluid from the suppression pool to flow into the cooling coils to condense and cool the fluid; and
draining the condensed and cooled fluid from the cooling coil into the suppression pool.
